(19) United States
(12) Patent Application Publication
(10) Pub. No.: US 2005/0274932 A1
(43) Pub. Date: Dec. 15, 2005

(54) Shielding for electromagnetic interference

(75) Inventors: Fiona Eleanor Knight, Silverstone (GB); Martin Roy Harrison, Evenley (GB); James Hugh Vincent, Shenley Brook End (GB); Peter Hawkins, Northampton (GB)

Correspondence Address: LAHIVE & COCKFIELD, LLP., 28 STATE STREET, BOSTON, MA, 02109, US

(73) Assignee: Bookham Technology, Plc, Abingdon (GB)

(21) Appl. No.: 10/496,629

(22) PCT Filed: Nov. 25, 2002
(86) PCT No.: PCT/GB02/05266

§ 371 Date: Jun. 28, 2005

(30) Foreign Application Priority Data
Nov. 23, 2001 (GB) 0128208.6

(51) Int. Cl. H01B 1/00

(52) U.S. Cl. 252/500

(57) ABSTRACT

An electromagnetic shield that comprises at least a portion formed from a material comprising liquid crystal polymer incorporating an electrically conductive filler, the material having a coefficient of linear thermal expansion, in at least one direction, in the range 1 to 20 ppmK⁻¹ and/or having a electrical conductivity in the range 1 to 1000 Siemens/m.

### FIELD

This invention relates to shielding devices for electromagnetic radiation and in particular to the shielding of integrated circuits and opto-electronic systems.

### BACKGROUND

Electromagnetic interference (EMI) is an increasing problem in modern electronic systems with a need to protect components and systems against external electromagnetic interference (EMI) and a requirement to prevent the electromagnetic radiation emitted from components and systems from interacting with nearby equipment.

An electronic system is composed of circuit components, such as wires, printed circuit boards, conductors, connector elements, connector pins, cables, and the like and any propagating electrical signal, which is periodic in nature, will cause said elements to radiate electromagnetic radiation. Circuit elements are effective in radiating electromagnetic radiation that has wavelengths similar to the radiating element dimensions. Thus long circuit elements will be more effective in radiating low frequency radiation, and short circuit elements will be more effective in radiating high frequency radiation. These circuit elements behave just like antennae that are designed for the transmission of the radiating wavelengths.

Integrated circuits (ICs) are designed to work at high frequencies such as found in computing and opto-electronic systems. When such components are operating at such high frequencies, for example in opto-electronic systems when a 5V signal is being switched at 40 GHz, a large amount of electromagnetic radiation is emitted. This potentially can cause problems for both separate electronic systems and also other components within the system. The coupling of electromagnetic radiation to nearby components is called crosstalk and although the design of circuit interconnections can reduce the effect, it still remains a significant problem.

Electronic systems are becoming smaller, and the density of electrical components in these systems is increasing. As a result, the dimensions of the average circuit element are decreasing, favouring the radiation of higher and higher frequency signals. At the same time, the operating frequency of these electrical systems is increasing, further favouring the incidence of high frequency EMI. EMI can come from electrical systems distant from a sensitive receiving circuit, or the source of the noise can come from a circuit within the same system (crosstalk or near source radiated emission coupling). The additive effect of all these sources of noise is to degrade the performance, or to induce errors insensitive systems.

The use of plastic materials has found great favour in the electronics industry for forming lightweight, strong packaging solutions. However plastics are generally transparent to high frequency (>100 MHz) electromagnetic radiation and the base materials need to be modified to provide EMI shielding.

When packaging electronic components there are constraints on the types of material systems that can be used. For example, opto-electronic components within a package have to be positioned with a high degree of accuracy and the alignment of the optical components must be maintained. In phased-array antenna packages the microwave monolithic integrated circuit (MMIC) package should be smaller than half the wavelength to permit the proper antenna element spacing. Thus at frequencies of 20-40 GHz packages smaller than 2 cm square are required. The materials used to construct the packaging must be such that they ideally have no detrimental impact on the function of the components.

The conventional material used for packaging microwave monolithic integrated circuits (MMIC) and opto-electronic components is Kovar, which is a nickel-iron-cobalt controlled expansion alloy typically containing 53% Fe, 29% nickel, 17% Co. It has a coefficient of expansion that matches that of the alumina ceramics on which the components are mounted. Kovar can be gold plated, provided that there is an under plating of electroplated nickel. Kovar offers good corrosion resistance and can be machined and drawn and welded to itself; it is however denser and heavier than aluminium.

Electromagnetic interference (EMI) shielding of electric equipment is traditionally based on the use of either metal equipment cases, such as Kovar, or plastic cases coated with a metal layer. In addition, methods are known for manufacturing cases of a conductive plastic composite where conductive particles, such as carbon black, carbon fibres, metal fibres or metal flakes are mixed with the insulating polymer. Such polymers include polyesters, polycarbonates, copolyestercarbonates, polyamides, polyarylene ether sulphones or ketones, polyamide imides, polyetherimides, polyethylene ethers, polystyrenes, polyphenylene sulphide, and acrylonitrile butadiene styrene copolymers or blends thereof.

Although such solutions are effective at screening the components from external electromagnetic radiation and preventing any generated electromagnetic radiation from being radiated there are a number of problems with such solutions.

1. Metal cases and polymers heavily loaded with a suitable filler act as efficient screens by acting as reflectors to the electromagnetic radiation. As a consequence of this, standing waves are set up within the case and enhanced crosstalk due to resonance occurs, both between different devices and between one device and the reflection of its emitted electromagnetic radiation.

To overcome the problem of resonance it is known in the art that the insertion of materials that absorb electromagnetic radiation, commonly known as radar absorbing materials (RAM), is effective. However such materials have poor mechanical properties and there are problems in making good electrical connection to the metal casing. The fixing of the RAM inserts is time consuming, labour intensive and costly. The use of adhesives within the enclosure can also be problematical due to issues of out-gassing.

2. Metal cases have to be made out of alloys such as Kovar which have a coefficient of thermal expansion which matches that of the alumina ceramic tiles on which the opto-electronic components are mounted. Such cases are expensive and heavy.

3. Plastic cases do not generally have a coefficient of thermal expansion that matches that of the alumina ceramic tiles on which the opto-electronic components are mounted. Such differences in the coefficient of thermal expansion can cause the optical components to move out of alignment and in extreme cases cause the ceramic tiles to crack.

4. Plastic cases with metallic coating are susceptible to damage and once the metal coating is interrupted or scratched their screening efficiency is greatly reduced.

5. For some plastic materials it may be difficult to achieve good adhesion of the metal coating to the plastic. The plastic can be treated to improve adhesion by such means as plasma treatments but such processes are not always successful and add to the cost.

What is required is an enclosure or shield which serves two requirements, namely:
1. to prevent the radiation of generated electromagnetic radiation, to protect components from external electro-magnetic radiation and prevent the setting up of electro-magnetic radiation resonance within the enclosure which can both impair the functionality of the device and cause damage to components; and
2. to provide the required degree of mechanical support for the components and provide at least in the critical direction a thermal expansion match to the enclosed component(s) and/or a support (for example a ceramic support) on which the component(s) may be mounted.

The enclosure must also not affect the components, or increase the system size, weight or cost. It should also preferably be formed from a polymeric material that can be injection moulded to a high degree of accuracy.

### OBJECT OF THE INVENTION

The invention seeks to provide a shield or an enclosure suitable for the housing of microelectronic and/or optoelectronic circuitry sensitive to and/or emitting high frequency electromagnetic radiation and which preferably also functions as an effective packaging.

### STATEMENTS OF INVENTION

A first aspect of the present invention provides an electromagnetic shield that comprises at least a portion formed from a material comprising liquid crystal polymer incorporating an electrically conductive filler, the material having a coefficient of linear thermal expansion, in at least one direction, in the range 1 to 20 ppmK⁻¹.

A second aspect of the invention provides an electromagnetic shield that comprises at least a portion formed from a material comprising liquid crystal polymer incorporating an electrically conductive filler, the material having an electrical conductivity in the range 1 to 1000 Siemens/m (corresponding to an electrical resistivity in the range 100-0.1 Ohm-cm).

The filler may comprise at least one of carbon black, metal fibres, metal flake, metal powder, carbon nanotubes and preferably carbon fibre. By using fibre filler (or another anisotropically shaped filler) it is possible to establish a direction in which the coefficient of thermal expansion may be controlled, for example

Controlling the coefficient of linear thermal expansion (in at least one direction), and especially substantially, matching it to that of an electronic or opto-electronic component and/or a support on which such a component is mounted, has the great advantage of reducing (or preferably, substantially eliminating) thermally-induced distortions and/or misalignments in the component. Consequently, this can be critical to the reliable functioning of the component.

The material preferably has an electrical conductivity in the range 2 to 100 Siemens/m, more preferably in the range 3 to 50 Siemens/m, even more preferably in the range 5 to 20 Siemens/m.

The material preferably has a coefficient of linear thermal expansion, in at least one direction, in the range 2 to 15 ppmK⁻¹, more preferably in the range 2 to 7 ppmK¹.

The electromagnetic shield preferably functions as a shield to electromagnetic radiation substantially entirely by the absorption thereof. Preferably the shield functions as a shield to electromagnetic radiation substantially without the reflection thereof.

The material preferably comprises 10 to 35% by volume of filler, more preferably 15 to 30% by volume of filler.

For embodiments in which the filler comprises carbon fibres, they preferably have length of between 100-300 μm and a diameter of between: 5-15 μm, and more preferably have a length of about 200 μm and a diameter of about 7.0 μm.

The liquid crystal polymers are generally aromatic copolyesters formed by the condensation of monomer units derived from one or more monomers selected from a group consisting of para hydroxybenzoic acid, hydroxy napthonic acid, hydroqinone terephthalic acid and isophthalic acid. Such materials are commercially available from a number of sources e.g Dupont, Eastman, Mitsubishi.

The composite polymer, that is the polymer/filler mix, preferably meets certain mechanical properties that are determined by the requirements of the components that are to be housed within the enclosure. The polymer may have the following physical properties:

No substantial phase transition within the temperature range −40° C. to 125° C.

Coefficient of thermal expansion which matches that of the critical component in one direction, typically 6 ppmK⁻¹.

A low permeability to moisture.

Electrical conductivity in the range 1-1000 Siemens/m (corresponding to an electrical resistivity in the range 100-0.1 Ohm-cm).

The composite polymer should preferably be capable of injection moulding and the mechanical properties should preferably be such that it has a very high melt flow under shear i.e. such that it is possible to mould complicated, thin features without voids and flashing occurring.

Preferably, in said portion(s) the carbon fibres; (or other anisotropically shaped filler particles, fibres or tubes) are substantially anisotropically aligned to tailor the co-efficient of thermal expansion In a required direction.

The enclosure or shield may also comprise other portions formed from liquid crystal polymer filled with an electrically non-conductive material e.g. glass fibre.

The shield may comprise a housing having a lid, and in use may house at least one radiation emitting component, wherein said portion comprises at least one wall extending from the lid to divide the housing into separate areas with improved interference isolation. For a single elongate component this may reduce crosstalk between parts thereof.

Typically the housing in use houses two or more components and said wall(s) divide(s) the housing into respective areas for each component.

Said portion may also comprise the lid of the housing. Said portion may comprise straight or curved walls which substantially surround each component. Straight walls may be joined to surround each component on at least three sides thereof.

Another aspect of the invention provides a packaged electronic and/or optoelectronic component comprising a housing according to the invention containing the component, wherein the shield has a coefficient of linear thermal expansion that substantially matches that of the component and/or a support on which the component is mounted, in at least one direction.

Also according to the invention there is provided a method of providing an electromagnetic shield for an integrated circuit wherein the circuit is located in a housing according to the invention.

### DESCRIPTION OF THE DRAWINGS

The invention will be described by way of example and with reference to the accompanying drawings in which:—

FIG. 1 is a section through a first shielding enclosure according to the invention which houses two active components,

FIG. 2 longitudinal section through a second enclosure also according to the invention,

FIG. 3 is a plan section through the second enclosure,

FIG. 4 shows an anisotropic arrangement of fibres within the polymeric material,

FIGS. 5 & 6 show a modified arrangement of the enclosure of FIGS. 2 & 3,

FIG. 7 shows a modified arrangement of the first enclosure,

FIG. 8 is a graph of sensitivity vs Frequency for the enclosure of FIG. 7 having shielding material with a first resistivity, and

FIG. 9 is a graph as shown in FIG. 8 for a housing having shielding material with a higher resistivity to that of the material used for FIG. 8.

### DETAILED DESCRIPTION OF THE INVENTION

When using a prior art all-metal enclosure it is found that there is excellent external screening i.e. the outside environment is well protected from any EMI. However it had been found that using a metal enclosure with smooth walls sets up large resonances within the enclosure as the electromagnetic radiation is reflected from the metal sidewalls and metal lid.

For the particular application of packaging of optoelectronic components it has been found that liquid crystal polymers (LCP) based materials, preferably carbon fibre (CF) filled LCP, are particularly useful. CF filled LCP composites can be tailored to provide a thermal expansion match in substantially one direction with for example GaAs components Liquid crystal polymers are generally aromatic copolyesters formed by the condensation of monomer units derived from one or more monomers such as para hydroxybenzoic acid, hydroxy napthonic acid, hydroqinone, terephthalic acid and isophthalic acid.

The general structure is thus [—CO—Ar—COO—Ar′—O—] where Ar and Ar can vary and be single, multiple or bridged aromatic structures.

Such liquid crystal polymers (LCP), loaded with filler to modify the mechanical and electrical properties, are available from a variety of commercial suppliers e.g Polyone, RTP, Ticona, Eastman, Mitsubishi, and BP Amoco.

The preferred EMI shielding material is LCP filled with carbon fibre. When using carbon fibres, it is preferred that the fibres should have a length of 100 μm to 300 μm and a diameter of 5 μm to 15 μm and in particular should be 200 μm in length and 7 μm in diameter are effective. Such a material is Vectra 8230, supplied by Ticona. The Vectra 8230 was used to form at least portions of an enclosure for MMIC amplifier chips used in conjunction with opto-electronic components. The amplifier consists of two gain stages that operate independently of each other. The carbon fibre composite has a radio frequency (1-50 GHz) resistivity in the range 0.1-100 Ohm-cm (corresponding to a conductivity In the range 1-1000 Siemens/m).

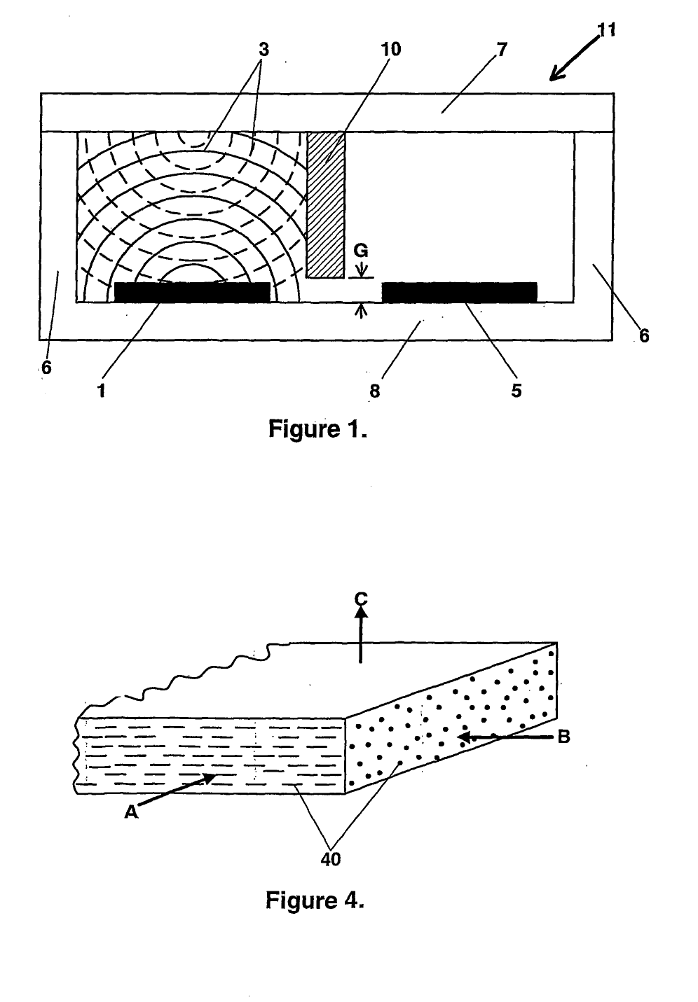

With reference to FIG. 1, the invention is an enclosure, sometimes referred to as a shield 11, shielding, housing, casing or package, that provides electromagnetic radiation shielding for microelectronic components 1 & 5. The present enclosure 11 has metal walls 6 and a metal lid 7 with a partition wall 10 attached to the lid 7 and extending across the width of the enclosure such that it makes intimate contact with the sidewalls. The wall 10 extends down so that it is in close proximity to the base 8 of the enclosure. The wall 10 does not have to touch the base 8 of the enclosure. The partition wall 10 is formed from a carbon fibre (CF) filled liquid crystal polymer (LCP) composite material.

The wall 10 extends down until it almost touches the circuit board on which the chips 1 & 5 are mounted. It is not necessary for the insert to touch the circuit board in order to prevent crosstalk. As long as the gap G is less than approximately 500 μm then there is negligible transmitted radiation. The wall 10 in use absorbs a substantial amount of the emitted and reflected radiation 3. The wall 10 is preferably not secured to the lid 7 by adhesives due to potential problems with out gassing.

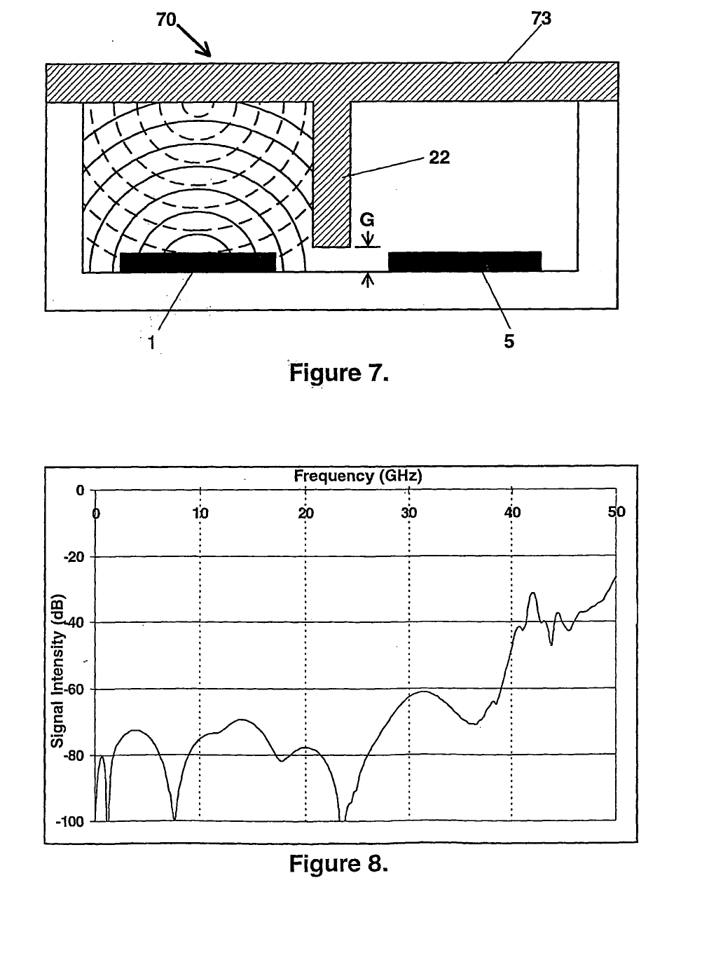

Replacing the metal lid 7 with one formed from CF filled LCP (Vectra 8230), has a significant further improvement in the isolation of the chips from DC to 40 GHz. The lid contributes to the absorption of electromagnetic radiation and reduces resonances as is discussed later with reference to FIG. 7

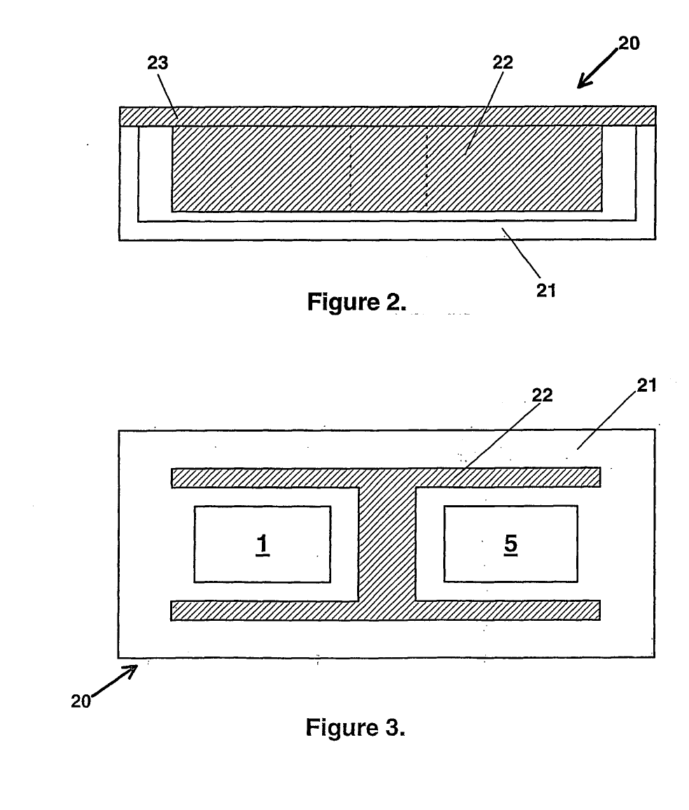

Although the embodiment in FIG. 1 may be satisfactory for some applications there may still be some reflections from the sidewalls of the enclosure. Referring now to FIGS. 2 & 3, an improved enclosure 20 is gained by using EMI shielding walls 22 extending downwardly from the lid 23 and linked to form an H shape continuous partition such that the components 1 and 5 are enclosed on three sides as shown in FIG. 3. The walls 22 and lid 23 may both be formed of the carbon, fibre filled LCP.

The embodiments shown in FIGS. 1-3 may also house a single component and the CF filled LCP wall(s) give improved free space radiation isolation and elimination of resonance between areas of the enclosed component. For example a GaAs electro-optic modulator as shown in GB-A-2361071 at faster propagation speeds requires isolation between its input and output.

The enclosure 20 both prevents the emission of electro-magnetic radiation out into the environment and also prevents resonance within the package that could affect components by absorbing some or all of the emitted electromagnetic radiation.

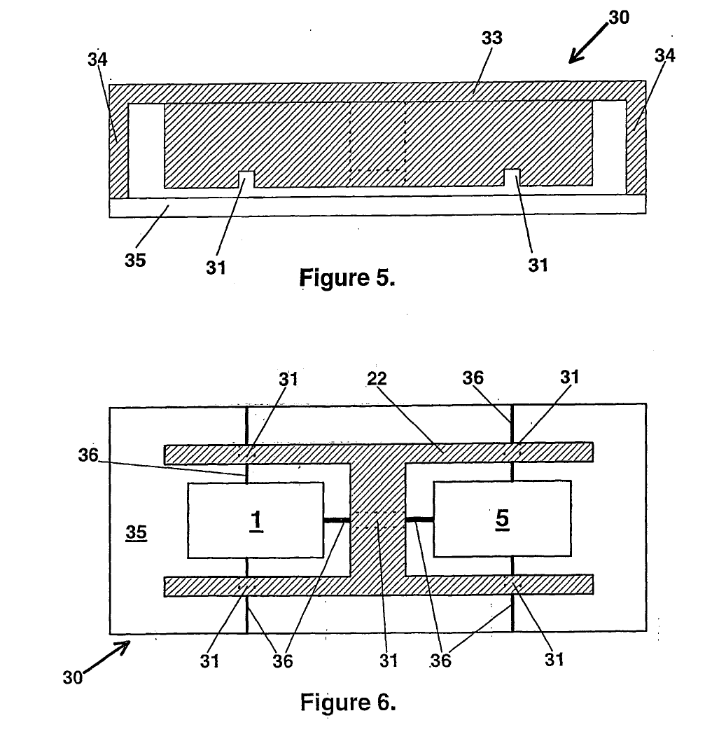

With reference now to FIGS. 5 and 6, there is shown an enclosure 30 for use with components 1 & 5 mounted on a substrate 35 and connected together by RF transmission lines 36. Such transmission lines will radiate electric fields. A potential problem occurs when the RF absorbing material is brought too close to the transmission lines and starts to interact with the RF fields of the transmission lines and such interactions will degrade the performance of the system. The walls 22 are the same H-shape as in FIGS. 2 & 3 and the lid 33 has EMI shielding peripheral sidewalls 34 also formed from CF filled LCP. The walls 22 are modified with notches 31 so that they are not in close proximity to the transmission lines 36. The transmission lines 36 are shown connecting components to each other and allowing connection to be made to elements outside the enclosure.

The spacing of these notches 31 is such that there is still no significant crosstalk between components. This is possible because of the electromagnetic radiation which intersects with the material is not significantly absorbed in the direction of the transmission line. This allows polymeric inserts to be used within the casing near to transmission lines without significantly degrading component performance.

FIG. 4 shows, merely schematically, the orientation of the carbon fibres 40 giving rise to anisotropic properties. In direction B the co-efficient thermal expansion of the composite is tailored to substantially match that of the component material, for example GaAs. There is no control of the thermal expansion of the composite in the direction A. (In reality, the carbon fibres 40 will not be perfectly aligned, but will have a statistical distribution of orientations. The thermal expansion coefficient will generally be controlled by controlling the extent to which the fibres are misaligned.)

With reference to FIGS. 7 & 8, the resistivity of the shielding material has an effect on the performance of the material as an absorber of RF radiation. An enclosure 70 is similar to the enclosure 11 except that the lid 73 is also formed from CF filled LCP. The components 1 & 5 emit RF radiation and FIG. 8 shows the results if the material has a conductivity of approximately 1000 Siemens/m (i.e. a resistivity of approximately 0.1 Ohm-cm). As can be seen from FIG. 8 the amount of unwanted resonance is reduced although there is still a significant peak at approximately 42 GHz.

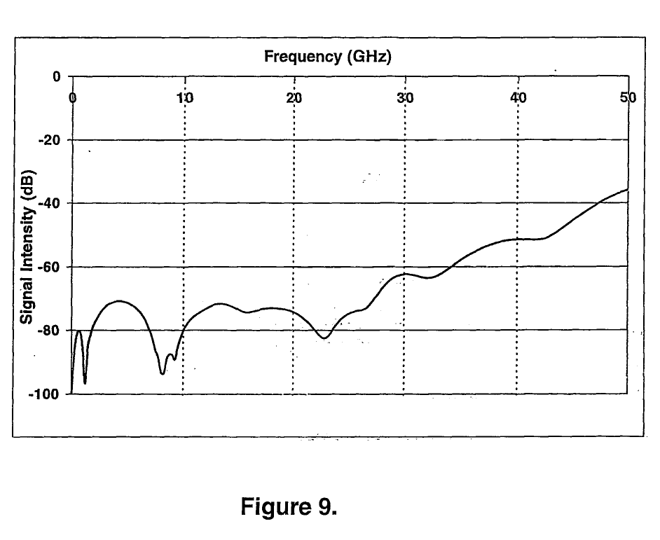

FIG. 9 shows the results if the shielding material has a conductivity of approximately 10 Siemens/m (i.e. a resistivity of approximately 10 Ohm-cm). As can be seen compared to FIG. 8 there is more absorption of the electromagnetic radiation and the resonance at 42 GHz has been removed.

The CF filled LCP can be injection, moulded to form complicated, thin features such as the dividing walls and the coefficient of expansion is a sufficiently close match to that of the prior art Kovar metal casing so that it is possible to form an hermetic seal between, a moulded filled LCP lid and a metal casing.

It is possible to form substantially the whole of any casing from the CF filled LCP that to provide for a maximum amount of RF absorption. To produce casings substantially from CF filled LCP it is necessary that regions of the casing are not conductive so that it is possible to have electrical connections and feed throughs. The polymer is intrinsically an insulator in the unloaded state however the mechanical properties of the unloaded polymer will not match the mechanical properties of the loaded conductive polymer. In order to match these mechanical properties the polymer has to be loaded with a suitable material. Typically glass fibre is used but any inert electrically insulating material, which modifies the mechanical properties of the polymer to match that of the conductive polymer, may be used. The ability to co-mould LCP having different fillers to form insulating regions suitable for external connections and conductive regions for electromagnetic radiation suppression allows for the formation of highly functional enclosures.

Although the examples shown above use carbon fibre to make the 5 material conductive this is not the only means of doing so. Metal fibres, metal flakes, metal powders, carbon nanotubes are examples of means of modifying the conductivity of the polymers. Care must be taken when choosing the filler material that the mechanical properties of the polymer, especially the coefficient of thermal expansion, are not degraded to fall outside of the design parameters. It has been found that the suitability of the filled LCP for use as an electromagnetic radiation absorbing/screening material is effectively independent of the dielectric constant of the material. An important parameter is the conductivity of the material, which preferably is approximately 10 Siemens/m (i.e. a resistivity of 10 Ohm-cm).

When using other filler systems different dimensional tolerances will apply. The design of the package also plays a key role in the prevention of the emission of electromagnetic radiation out into the environment, the isolation of one part of the circuit from another, and the prevention of resonance within the package that could damage components.

1. An electromagnetic shield, comprising at least a portion formed from a material including liquid crystal polymer incorporating an electrically conductive filler, the material having a coefficient of linear thermal expansion, in at least one direction, in the range of 1 to 20 ppmK⁻¹, wherein the material has an electrical conductivity in the range of 1 to 1000 Siemens/m.

2-3. (canceled)

4. The shield according to claim 1, wherein the material has an electrical conductivity in the range of 2 to 100 Siemens/m.

5. The shield according to claim 1, wherein the material has an electrical conductivity in the range of 3 to 50 Siemens/m.

6. The shield according to claim 1, wherein the material has an electrical conductivity in the range of 5 to 20 Siemens/m.

7. The shield according to claim 1, wherein the material has a coefficient of linear thermal expansion, in at least one direction, in the range of 2 to 15 ppmK⁻¹.

8. The shield according to claim 1, wherein the material has a coefficient of linear thermal expansion, in at least one direction, in the range of 2 to 7 ppmK⁻¹.

9. The shield according to claim 1, which functions as a shield to electromagnetic radiation substantially entirely by the absorption thereof.

10. The shield according to claim 1, which functions as a shield to electromagnetic radiation substantially without the reflection thereof.

11. The shield according to claim 1, wherein the filler comprises at least one of carbon nanotubes and carbon fibres.

12. The shield according to claim 1, wherein the material comprises 10 to 35% by volume of filler.

13. The shield according to claim 12, wherein the material comprises 15 to 30% by volume of filler.

14. The shield according to claim 11, wherein the filler comprises carbon fibres having a length in the range of 100-300 μm and a diameter in the range of 5-15 μm.

15. The shield according to claim 14, wherein the carbon fibres have a length in the range of 150-250 μm and a diameter in the range of 5-9 μm.

16. The shield according to claim 1, wherein the filler comprises anisotropically shaped particles, fibres, flakes or tubes that are substantially anisotropically oriented within the polymer.

17. The shield according to claim 1, wherein the polymer undergoes no substantial phase transition within the temperature range of −40° C. to 125° C.

18. The shield according to claim 1, wherein the shield further comprises at least one other portion formed from liquid crystal polymer incorporating an electrically non-conductive material.

19. The housing for a radiation emitting component, at least a part of which comprises a shield according to claim 1.

20. The housing according to claim 19, comprising a lid, a base, and at least one wall extending from the lid towards the base to divide the housing into separate areas.

21. The housing according to claim 20, configured for housing at least two components, wherein the wall divides the housing into respective areas for each component.

22. The housing according to claim 19, wherein the shield comprises straight or curved walls that substantially surround the component.

23. The housing according to claim 19, wherein the shield forms at least one of the lid and the base of the housing.

24. A packaged electronic or optoelectronic component comprising a housing according to claim 19 containing the component, wherein the shield has a coefficient of linear thermal expansion that substantially matches one of the component and a support on which the component is mounted, in at least one direction.

25. The packaged component according to claim 24, wherein the support comprises ceramic.

26. A method of providing an electromagnetic shield for an integrated circuit, comprising locating the circuit in a housing according to claim 19.

27. The shield according to claim 1, wherein the material has a coefficient of linear thermal expansion, in at least one direction, in the range of 2 to 15 ppmK⁻¹.

28. The shield according to claim 1, wherein the material has a coefficient of linear thermal expansion, in at least one direction, in the range of 2 to 7 ppmK⁻¹.

29. The shield according to claim 1, which functions as a shield to electromagnetic radiation substantially entirely by the absorption thereof.

30. The shield according to claim 1, which functions as a shield to electromagnetic radiation substantially without the reflection thereof.

31. The shield according to claim 1, wherein the filler comprises at least one of carbon nanotubes and carbon fibres.

32. The shield according to claim 1, wherein the filler comprises anisotropically shaped particles, fibres, flakes or tubes that are substantially anisotropically oriented within the polymer.

33. A housing for radiation emitting component, at least a part of which comprises a shield according to claim 1.

34. The housing according to claim 33, comprising a lid, a base, and at least one wall extending from the lid towards the base to divide the housing into separate areas.
